(19) United States
(12) Patent Application Publication
(10) Pub. No.: US 2026/0059502 A1
(43) Pub. Date: Feb. 26, 2026

(54) METHOD, DEVICE, AND MEDIUM FOR COMMUNICATION

(71) Applicant: NEC Corporation, Tokyo (JP)

(72) Inventors: Ying ZHAO, Beijing (CN); Zhaobang MIAO, Beijing (CN); Gang WANG, Beijing (CN)

(73) Assignee: NEC Corporation, Tokyo (JP)

(21) Appl. No.: 19/102,542

(22) PCT Filed: Aug. 11, 2022
(86) PCT No.: PCT/CN2022/111925

§ 371 Date: Feb. 10, 2025

(51) Int. Cl. H04W 72/0446; H04W 72/25

(52) U.S. Cl. CPC H04W 72/0446; H04W 72/25

(57) ABSTRACT

Example embodiments of the present disclosure relate to a solution for resource allocation configuration for a sidelink reference signal. In this solution, a first communication device obtains a resource allocation configuration for a sidelink reference signal, the resource allocation configuration comprising: a first resource allocation configuration indicating a resource pool set and a time-frequency location in the resource pool set, the resource pool set comprising a plurality of resource pools for sidelink communication, or a second resource allocation configuration indicating a number of resource units selected from a dedicated resource pool for communication of the sidelink reference signal, a resource unit being of a predetermined bandwidth. The first communication device determines a resource allocated for the sidelink reference signal based on the resource allocation configuration, and performs communication of the sidelink reference signal with at least one second communication device using the determined resource.

### FIELD

Example embodiments of the present disclosure generally relate to the field of communication techniques and in particular, to a method, device, and medium for resource allocation configuration for a sidelink reference signal (SL-RS).

### BACKGROUND

A sidelink (SL) refers to a communication mode in which a direct link is established between communication devices, e.g., terminal devices, and data or information is directly exchanged between terminal devices without going through a network device. In sidelink communications, a sidelink reference signal (SL-RS) may be exchanged between communication devices for many applications. For example, a communication device (e.g., a terminal device) may be configured to determine its own position and/or the position of other communication devices based on SL-RSs (e.g., positioning reference signals (PRSs)) exchanged with the other communication devices. Generally, resource allocation may be configured for communication of the SL-RS.

### SUMMARY

In general, embodiments of the present disclosure provide methods, devices and computer storage medium for resource allocation configuration for a sidelink reference signal.

In a first aspect, there is provided a communication method. The method comprises: obtaining, at a first communication device, a resource allocation configuration for a sidelink reference signal, the resource allocation configuration comprising: a first resource allocation configuration indicating a resource pool set and a time-frequency location in the resource pool set, the resource pool set comprising a plurality of resource pools for sidelink communication, or a second resource allocation configuration indicating a number of resource units selected from a dedicated resource pool for communication of the sidelink reference signal, a resource unit being of a predetermined bandwidth; determining a resource allocated for the sidelink reference signal based on the resource allocation configuration; and performing communication of the sidelink reference signal with at least one second communication device using the determined resource.

In a second aspect, there is provided a communication device. The communication device includes a processing unit; and a memory coupled to the processing unit and storing instructions thereon, the instructions, when executed by the processing unit, causing the device to perform the method according to the first aspect.

In a third aspect, there is provided a computer readable medium having instructions stored thereon, the instructions, when executed on at least one processor, causing the at least one processor to carry out the method according to the first aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a flowchart of a process for resource allocation for a sidelink reference signal according to some embodiments of the present disclosure;

FIG. 3A and FIG. 3B illustrate schematic diagrams of some examples of a resource allocation configuration for a SL-RS according to some embodiments of the present disclosure;

FIG. 4A and FIG. 4B illustrate schematic diagrams of some examples of a resource allocation configuration for a SL-RS according to some further embodiments of the present disclosure;

FIG. 5A to FIG. 5D illustrate schematic diagrams of some examples of a resource allocation configuration for a SL-RS according to some further embodiments of the present disclosure;

FIG. 6A and FIG. 6B illustrate schematic diagrams of some examples of a resource allocation configuration for a SL-RS and control information according to some embodiments of the present disclosure;

FIG. 7A to FIG. 7E illustrate schematic diagrams of some examples of a resource allocation configuration for a SL-RS and control information according to some embodiments of the present disclosure;

FIG. 8A and FIG. 8B illustrate schematic diagrams of some examples of a resource allocation configuration for a SL-RS according to some further embodiments of the present disclosure;

FIG. 9 illustrates schematic diagrams of an example of a resource allocation configuration for a SL-RS according to some further embodiments of the present disclosure;

FIG. 10A to FIG. 10D illustrate schematic diagrams of some examples of a resource allocation configuration for a SL-RS according to some further embodiments of the present disclosure;

FIG. 11A and FIG. 11B illustrate schematic diagrams of some examples of a resource allocation configuration for a SL-RS according to some further embodiments of the present disclosure; and

FIG. 12 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

Embodiments of the present disclosure provide a solution for resource allocation for sidelink reference signal.

Principles and implementations of the present disclosure will be described in detail below with reference to the figures.

### Example of Communication Network

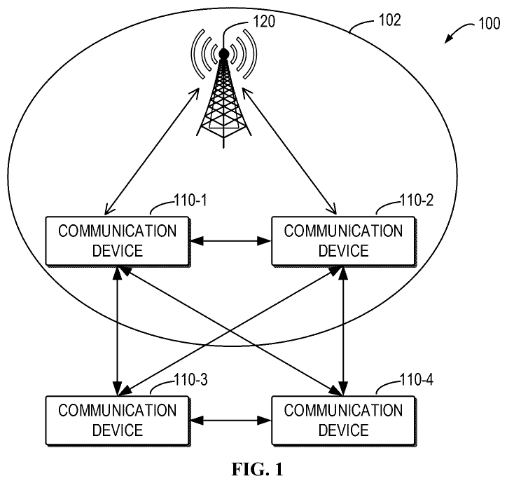

FIG. 1 illustrates a schematic diagram of an example communication environment 100 in which example embodiments of the present disclosure can be implemented.

The communication environment 100 includes a plurality of communication devices 110-1, 110-2, 110-3, 110-4, and 120. In FIG. 1, the communication devices 110-1, 110-2, 110-3, and 110-4 (collectively or individually referred to as communication devices 110) are illustrated as terminal devices. The communication device 120 is illustrated as a network device which provides a serving area 102 called a cell.

It is to be understood that the number of devices and their connections in FIG. 1 are given for the purpose of illustration without suggesting any limitations to the present disclosure. The communication environment 100 may include any suitable number of network devices and/or terminal devices adapted for implementing implementations of the present disclosure.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, a communication device 110 and a communication device 120 may communicate with each other via a channel such as a wireless communication channel on an air interface (e.g., Uu interface). The communication device 110 capable of communicating with the communication device 120 may be in coverage of the serving area 102 of the communication device 120. In the illustrated example of FIG. 1, the communication devices 110-1 and 110-2 may communicate with the communication device 120. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible. In the specific example of communication environment 100, a link from the communication device 110 to the communication device 120 is referred to as uplink, while a link from the communication device 120 to the communication device 110 is referred to as a downlink.

In some embodiments, the communication devices 110 may communicate with each other via a sidelink (SL) connection. A sidelink is a communication mode that allows direct communications between two or more terminal devices without the communications going through network device. SL communications may be carried out on a wireless interface, e.g., PC5 interface. SL communications may be unicast, groupcast, or broadcast, and may be used for device-to-device (D2D) communications, vehicle-to-everything (V2X) communications, emergency rescue applications, etc.

Depending on whether covered within a serving area of a network device or not, SL communication scenarios may include in-coverage, partial-coverage, and out-of-coverage (OOC). For example, in the illustrated example of FIG. 1, SL communications between the communication devices 110-1 and 110-2 are in-coverage of the communication device 120; SL communications between the communication devices 110-3 and 110-4 are out-of-coverage; while SL communication between. Partial-coverage may involve a scenario where a communication device 110 is within the network coverage area while the other communication device is outside the network coverage area. For example, in FIG. 1, SL communications between one of the communication devices 110-1 and 110-2 and one of the communication devices 110-3 and 110-4 may be partial-coverage.

In some cases, a network device facilitates the scheduling of resources for SL communications. In other cases, SL communications are carried out between the communication devices 110 without the involvement of a network device (e.g., the communication device 120).

SL resource allocation schemes may be applied for allocating resources in the SL resource pool for SL communications. There may be two SL resource allocation schemes. In a first SL resource allocation scheme (referred to as Model for SL resource allocation), the network device may schedule SL resources via the communication interface with the communication devices 110. The resource allocation may include dynamic grant, for example, by downlink control information (DCI), or configured grant (e.g., Type 1 or Type 2 configured grant). In a second SL resource allocation scheme (referred to as Mode2 for SL resource allocation), the resources for SL communications may be autonomously selected by the communication devices 110 based on a contention scheme.

In SL communications, a reference signal sent on a sidelink may be referred to as a sidelink reference signal (SL-RS). A SL-RS may be exchanged between the communication devices for many applications. For example, a communication device (e.g., a user equipment (UE)) may be configured to determine its own position and/or the position of other communication devices based on SL-RSs (e.g., positioning reference signals (PRSs)) exchanged with the other communication devices. In addition to the positioning, a SL-RS may be communicated to enable channel status determination of a sidelink, communication scheme determination, and/or for other purposes. In addition to the SL-PRS, a SL-RS may also include, for example, a channel status information reference signal (CSI RS), a sounding reference signal (SRS), or any other reference signals that need to be transmitted in SL communications.

A reference signal is generally known by both transmitter (TX) and receiver (RX) communication devices. In SL communications, resources may be allocated for a TX communication device to transmit a SL-RS and for a RX communication device to detect the SL-RS.

SL communications may be performed using resources from configured SL resource pools. Resource allocation configuration for a SL-RS is important considering resource unitization and detection accuracy of the SL-RS.

### Work Principle and Example Process

Example embodiments of the present disclosure provide a solution for resource allocation configuration for a SL-RS. In this solution, a resource allocated for a SL-RS is determined based on a resource allocation configuration which indicates a resource pool set comprising a plurality of resource pools for sidelink communication and a time-frequency location in the resource pool set. Alternatively, a resource allocated for a SL-RS is determined based on a resource allocation configuration which indicates a number of resource units selected from a dedicated resource pool for communication of the sidelink reference signal, a resource unit being of a predetermined bandwidth. A communication device determines the allocated resource based on the resource allocation configuration and performs communication of the SL-RS with at least one further communication device using the determined resource.

Through this solution, SL resource pools and/or a resource pool dedicated for the SL-RS can be configured to facilitate resource allocation for SL-RS transmission. The resource pool set or the dedicated resource pool may also be configured to support wideband SL-RS transmission in various SL communication scenarios.

Principles and implementations of the present disclosure will be described in detail below with reference to the figures.

Reference is made to FIG. 2, which illustrates a flowchart of a process 200 for resource allocation for a sidelink reference signal according to some example embodiments of the present disclosure. For the purpose of discussion, the process 200 will be described with reference to FIG. 1. The process 200 may be implemented at any one of the communications 110 in FIG. 1.

At block 210, the communication device 110 obtains a resource allocation configuration for a SL-RS.

In the process 200, the communication device 110 (sometimes referred to as a “first communication device” herein) may be any communication device having a SL connection with one or more other communication devices 110 (sometimes referred to as a “second communication device(s)” herein).

In some embodiments, the communication device 110 may receive information indicating part or all of the resource allocation configuration for the SL-RS from a network device, such as the communication device 120 in the example of FIG. 1. That is, the network device is configured to schedule resources for SL-RS transmission, for example, Model for resource allocation. In some embodiments, the communication device 110 may receive the information indicating part or all of the resource allocation configuration from the communication device 120 and transmit the information to one or more other communication devices 110 which are configured to receive or transmit the SL-RS.

In some embodiments, the communication device 110 may determine or may be configured with the resource allocation configuration for the SL-RS, for example, Mode2 for resource allocation. This communication device 110 may transmit the information indicating part or all of the resource allocation configuration to one or more other communication devices 110 which are configured to receive or transmit the SL-RS. In some embodiments, the communication device 110 may receive the information from one or more communication devices 110 via the SL connection therewith.

For example, in the case of sidelink positioning, a SL-PRS is communicated between a target device to be positioned and at least one anchor device according to different PRS-based positioning techniques. An anchor device may comprise any device that supports positioning of the target device. In some embodiments, it is assumed that the target device and at least one anchor device may have established a sidelink connection, for example, via a PC5 interface. In some embodiments, the target device may act as a TX device to transmit a SL-PRS to the anchor device(s). In some embodiments, one or more anchor device(s) may act as a TX device(s) to transmit a SL-PRS to the target device and/or other anchor device(s).

The communication device 110 implementing the process 200 may be either the target device or an anchor device. In some embodiments, the communication device 110 may either determine itself or receive the resource allocation configuration for a SL-PRS from a network device or another communication device 110. In some embodiments, this communication device 110 may transmit the information indicating the resource allocation configuration or part of the resource allocation configuration to other devices so they may determine the resource used for transmitting or receiving the SL-PRS. In some embodiments, the anchor device(s) may transmit or receive the SL-PRS through directional beams, where a SL-PRS directional beam corresponds to a certain spatial direction and coverage.

In some embodiments, in the case of sidelink positioning, in addition to the resource allocation configuration, assistance information for absolute positioning or relative positioning may be exchanged between the target device and at least one anchor device.

In embodiments of the present disclosure, a resource allocation configuration is proposed for SL-RS transmission. As will be described in below, some introductions or enhancements for the resource allocation configuration of a SL-RS are proposed. In some embodiments, information indicating the resource allocation configuration may be included in sidelink control information (SCI) to be transmitted to the communication device 110 or received from the communication device 110. In some embodiments, one or more new fields with the additional information related to the resource allocation configuration may be inserted to a legacy SCI format (such as SCI format 1-A, SCI format 1-B, SCI format 2-A, SCI format 2-B, SCI format 2-C) in sidelink communication. In some embodiments, one or more legacy fields in a legacy SCI format may be redefined or enhanced (with the same or different size) to indicate the information indicating the resource allocation configuration for the SL-RS. In some embodiments, a new SCI format (such as SCI format 1-X and/or SCI format 2-D) or media access control-control element (MAC CE) may be introduced to convey the information indicating the resource allocation configuration for the SL-RS. In some embodiments, the new SCI format may also include some information as included in the legacy format.

In some embodiments, information indicating the resource allocation configuration for a SL-RS may include one or more SL-RS resource related parameters for determining a resource(s) allocated for the SL-RS. The SL-RS resource related parameters may include sub-carrier spacing (SCS)/cyclic prefix (CP) for a SL-RS resource, SL-RS resource set configuration identity, SL-RS resource allocation configuration identity, SL-RS resource periodicity, the number of SL-RS resource repetition, the offset between two repeated instances of a SL-RS source, starting slot/symbol of a SL-RS resource, a comb size of a SL-RS resource and so on.

When determining a resource(s) for a SL-RS, the determination of these parameters may be based on a (pre)configuration (which may be conveyed in assistance information) and/or indications of applicable resource(s) by control information, for example, via DCI, SCI, and/or MAC-CE. That is to say, some of the SL-RS resource related parameters may be pre-configured, and some of the SL-RS resource related parameters may be indicated when resources for SL-RS transmission are needed or to be needed. For the latter, in some embodiments, some approaches may be applied to determine or indicate one or more SL-RS resource related parameters. In a first approach, an association between the SL-RS resource related parameter(s) and applicable resource(s) may be predefined. In a second approach, the SL-RS resource related parameter(s) may be indicated along with the time-frequency resource indication. For example, the SL-RS resource related parameter(s) may be indicated by a frequency resource indication value (FRIV) and a time resource indication value (TRIV), or may be indicated by information within one or more fields in a new DCI format, a new SCI format, or a new MAC-CE.

It would be appreciated that there may be other ways to convey information indicating the resource allocation configuration for a SL-RS, and the scope of the present disclosure is not limited in this regard.

Detailed description related to the resource allocation configuration proposed herein will be provided.

In some embodiments, a SL-RS may be communicated using a resource allocated across a plurality of resource pools for SL communication. As used herein, a resource pool for SL communication is also referred to as a “SL resource pool.” A SL resource pool may comprise a regular or common resource pool which is configured to the communication device 110 for SL communication, including communication of SL data and/or SL control information. As used herein, the term “SL communication,” “SL resource pool,” or “SL resource” may refer to any SL related communication, SL related resource pool or resource for SL data, SL-RS, and/or other SL control information. In some embodiments, the plurality of SL resource pools may be (pre)defined or (pre)configured as a resource pool set, which may enable transmission of wideband SL-RS as well as reusing legacy SL resource pools. In some embodiments, the plurality of SL resource pools may include one or more legacy SL resource pools. At least a part of frequency resources in each of the plurality of SL resource pools may be used for SL-RS transmission.

When allocating specific resources for a SL-RS, the communication device 110 obtains a first resource allocation configuration for a SL-RS, which indicates the resource pool set and a time-frequency location in the resource pool set. By allocating a resource across a plurality of resource pools, it is feasible to support transmission of a wideband SL-RS because the resource may be configured to have a larger bandwidth across the plurality of SL resource pools.

In some embodiments, a dedicated resource pool (DRP) is introduced for SL-RS communication. In some embodiments, a SL-RS may be communicated using a resource allocated from the dedicated resource pool. The dedicated resource pool is divided in a frequency domain into a plurality of resource units, and a resource unit is of a predetermined bandwidth. When allocating specific resources for a SL-RS, the communication device 110 obtains a second resource allocation configuration, which indicates a number of resource units selected from the dedicated resource pool for communication of the SL-RS.

Some example embodiments of the first and second resource allocation configurations will be described in detail below.

At block 220, the communication device 110 determines a resource(s) allocated for the SL-RS based on the resource allocation configuration.

As mentioned above, the communication device 110 may receive or determine itself information indicating the resource allocation configuration (e.g., the first resource allocation configuration or the second resource allocation configuration), such as one or more SL-RS resource related parameters. Based on the SL-RS resource related parameters, the communication device 110 may determine the allocated resource(s) for the SL-RS.

At block 230, the communication device 110 performs communication of the SL-RS with at least one further communication device 110 using the determined resource(s).

In some embodiments, the communication device 110 may be a TX device for the SL-RS and thus it may transmit the SL-RS to the at least one further communication device 110 using the allocated resource(s). In some embodiments, the communication device 110 may be a RX device for the SL-RS and thus it may detect the SL-RS transmitted by the other communication device 110 using the allocated resource(s).

### Resource Pool Set Based Configuration

As discussed above, a first resource allocation configuration for a SL-RS indicates a resource pool set and a time-frequency location in the resource pool set, the resource pool set comprising a plurality of SL resource pools for SL communication. In some embodiments, there may be a plurality of resource pool sets applicable for a SL-RS, each resource pool set comprising a different combination of two or more resource pools for SL communication. The number of SL resource pools comprised in each resource pool set may be predetermined and may be the same or different from each other. The first resource allocation configuration may indicate one of the plurality of applicable resource pool sets, for example, by a resource pool set related parameter represented as “R”.

In some embodiments, the plurality of SL resource pools in the resource pool set may at least be partially overlapped with each other in a time domain so that a resource at a specific time can be allocated from the resource pool set for a SL-RS.

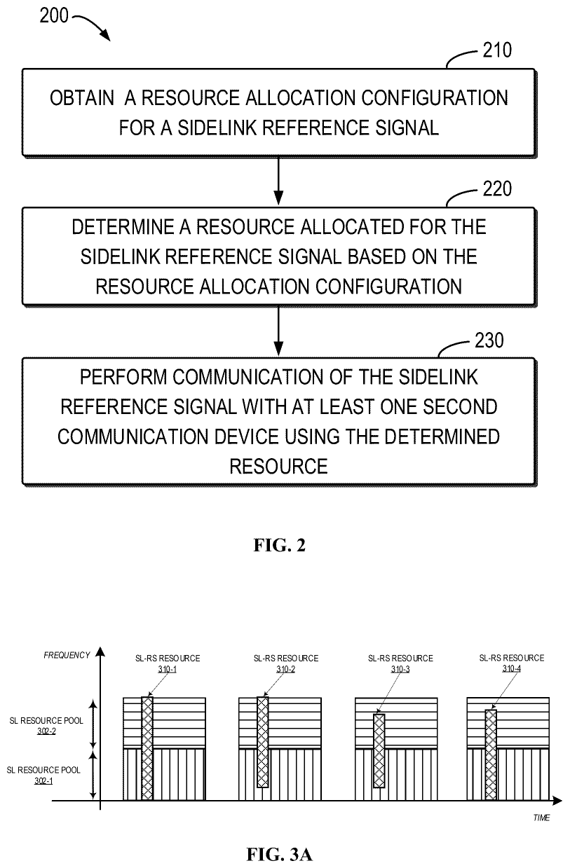

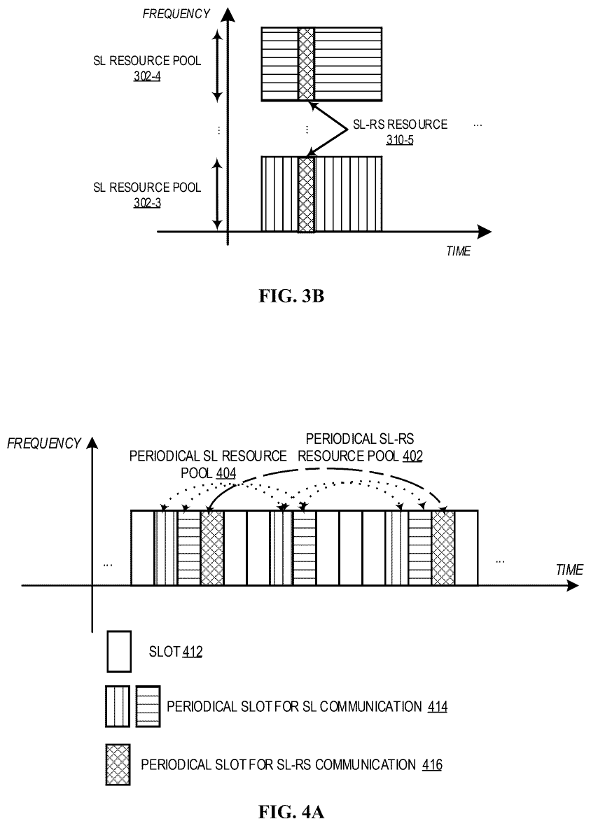

In some embodiments, a resource pool set may comprise at least two resource pools that are contiguous in a frequency domain. FIG. 3A illustrates an example of resource allocation for a SL-RS across a resource pool set. As illustrated, contiguous resource pools for SL communication (referred to as SL resource pools) 302-1 and 302-2 in the frequency domain are combined to form a resource pool set for a SL-RS. In this example, the SL resource pools 302-1 and 302-2 are substantially overlapped with each other in the time domain. However, it would be appreciated that the SL resource pools in a resource pool set may be partially overlapped in the time domain.

To specifically allocate a resource from the resource pool set, a time-frequency location in the resource pool set may be indicated. In some embodiments, for the contiguous resource pools, a resource for a SL-RS may be allocated as a combination of either all of the resource pools or the adjacent frequency parts of resource pool(s). For example, in FIG. 3A, a resource for a SL-RS (referred to as a SL-RS resource) 310-1 has a frequency bandwidth across all of the SL resource pools 302-1 and 302-2. A SL-RS resource 310-2 has a bandwidth of all the frequency band of the SL resource pool 302-1 and a frequency part of the SL resource pool 302-2. A SL-RS resource 310-3 has a bandwidth of adjacent parts of the SL resource pools 302-1 and 302-2, and a SL-RS resource 310-4 has a bandwidth of a frequency part of the SL resource pool 302-1 and all the frequency band of the SL resource pool 302-1. It is noted that the SL-RS resource may be allocated as having other combinations of the SL resource pools in the frequency domain.

In some embodiments, a resource pool set may comprise at least two SL resource pools that are non-contiguous in the frequency domain. That is, there may be a frequency gap between two SL resource pools in the resource pool set. FIG. 3B illustrates another example of resource allocation where a resource pool set comprising a SL resource pool 302-3 and a SL resource pool 302-4 that are not adjacent with each other in the frequency domain. In FIG. 3B, a SL-RS resource 310-5 is allocated as having a bandwidth across all the frequency bands of the SL resource pools 302-3 and 302-4. But similar as in FIG. 3A, a SL-RS resource may also be allocated as having a bandwidth of all or adjacent parts of two or more SL resource pools in the resource pool set.

It would be appreciated that the examples in FIG. 3A and FIG. 3B are provided for the purpose of illustration only. Although two SL resource pools are illustrated, in some other embodiments, a resource pool set from which a SL-RS resource is allocated may include more than two SL resource pools, in which case the SL-RS resource may be allocated as having the whole or partial bandwidths of two or more of those SL resource pools. In some embodiments, a resource pool set may comprise both contiguous SL resource pools and non-contiguous SL resource pools.

In some embodiments, a frequency threshold may be introduced. In the case of non-contiguous SL resource pools, it means that a SL-RS may be transmitted using a resource with a frequency gap. If a frequency gap between the plurality of SL resource pools in the resource pool set is within (e.g., less than or equal to) the frequency threshold, a joint detection may be applied to jointly detect the SL-RS transmitted on the plurality of SL resource pools. Otherwise, if the frequency gap between the plurality of SL resource pools in the resource pool set exceeds the frequency threshold, an independent detection may be applied to detect the SL-RS on each of the resource pools in the resource pool set. The independent detection may improve the success and accuracy in detecting the SL-RS when a resource gap is relatively large. Detection of the SL-RS may be performed by a communication device 110 which acts as a RX device of the SL-RS.

In some embodiments, the frequency threshold may be configured as a threshold parameter (represented as Fgap). In some embodiments, the frequency threshold may be configured, for example, when non-contiguous resource pools are included in the resource pool set. In some embodiments, if there are two or more frequency gaps between the SL resource pools in the resource pool set, any one or the largest one of the frequency gaps may be selected to be compared with the frequency threshold, or an aggregated value (e.g., an average) of the two or more frequency gaps may be compared with the frequency threshold, to determine whether the joint detection or independent detection is applied.

In some embodiments, in the time domain, a dedicated time slot (or just slot) is introduced for SL-RS communication. Accordingly, in the resource pool set based configuration, the first resource allocation configuration may indicate the dedicated time slot for a SL-RS. A SL resource pool in the resource pool set may be configured with the dedicated slot for SL-RS communication and thus may be referred to as a SL-RS resource pool.

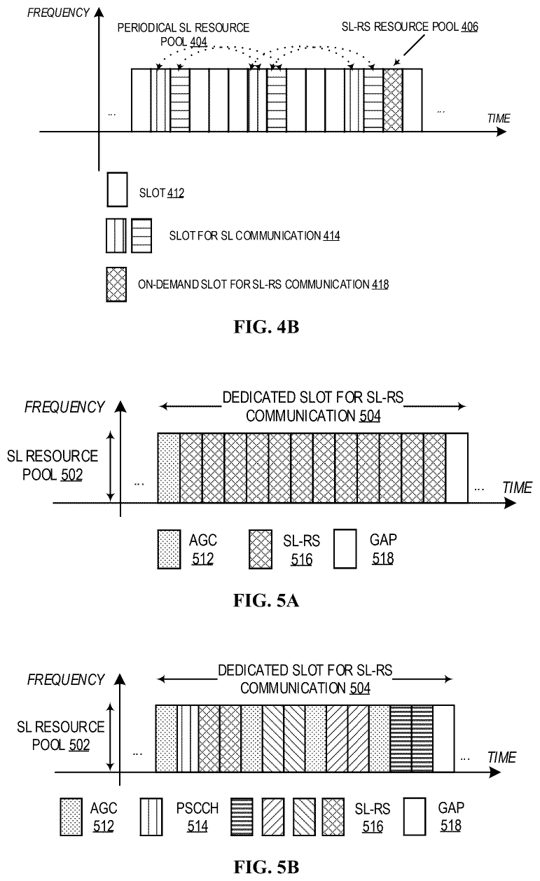

The dedicated time slot may be a periodical slot to convey periodical SL-RSs, or may be an on-demand slot for one-time or aperiodical SL-RS transmission. FIG. 4A and FIG. 4B illustrate examples of the first resource allocation configuration with a periodical slot and an on-demand slot for a SL-RS, respectively. As illustrated, in the time domain, there may be a plurality of slots. Slots 412 may be used for other communication, such as UL/DL communication, periodical slots 414 are configured for regular SL communication, and periodical slots 416 are dedicated for SL-RS communication.

In FIG. 4A, resources in the periodical slots 416 dedicated for SL-RS communications may be configured as a periodical SL-RS resource pool 402. In the resource pool set based configuration, each SL resource pool in the resource pool set may configured with the periodical slots for SL-RS communication. To allocate resources for SL-RS communication, this periodical dedicated slot may be configured to the corresponding communication device(s) 110 by configuring or preconfiguring its periodicity. In some embodiments, the periodicity of the dedicated slot for SL-RS communication may be the same as or different from the periodicity of the slots 414 for other SL communications.

In FIG. 4B, an on-demand slot 418 dedicated for SL-RS communication may be configured when a SL-RS is to be communicated among the communication devices 110. The time location of the on-demand dedicated slot 418 may be configured to the corresponding communication device(s) 110.

In some embodiments, if a dedicates slot is configured for SL-RS communication, a structure of the dedicated slot for SL-RS communication may be specifically defined. Generally, one slot for communication comprises a predetermined number of symbols in a certain structure. In addition to the SL-RS, symbols in the slot may be used to carry other information, such as automatic gain control (AGC) and physical sidelink control channel (PSCCH), and/or may be served as a gap. PSCCH may be used for carrying control information, such as SCI.

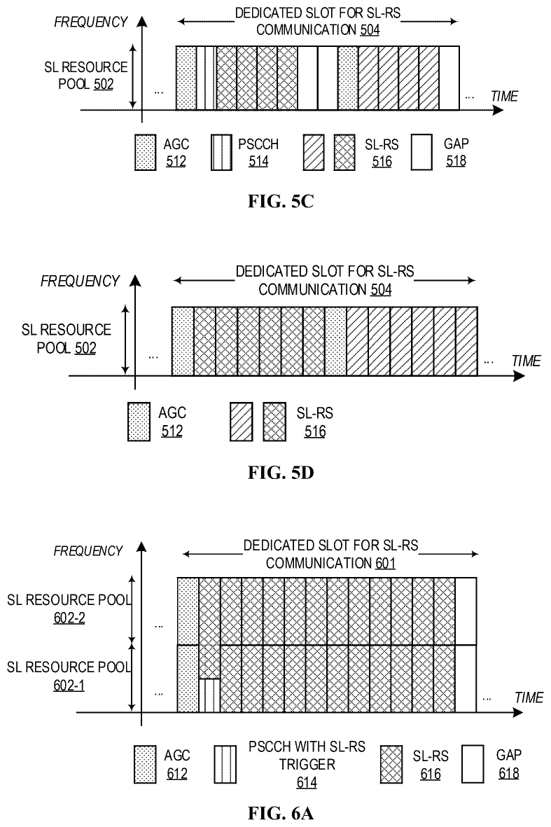

In some embodiments, the structure of the dedicated slot may be defined in such a way that all available symbols in the dedicated slot may be configured for transmitting a single SL-RS. In some embodiments, a symbol for AGC (referred to as an AGC symbol) may be configured as being ahead of a starting symbol of the symbols for SL-RS. FIG. 5A illustrates such an example. In FIG. 5A and following drawings, it is assumed that a slot comprises 14 symbols in total, although other number of symbols may also be possible. For the purpose of illustration, one SL resource pool 502 in a resource pool set is shown in FIG. 5A to FIG. 5D but it would be appreciated that the structure of the dedicated slot for SL-RS communication may be applied to other SL resource pools.

As illustrated in FIG. 5A, in addition to an AGC symbol 512 and a gap symbol 518, 12 symbols 516 in a dedicated slot 504 may be configured for transmitting a single SL-RS. That is, within the dedicated slot 504, a single12-symbol SL-RS may be transmitted. In FIG. 5A, the AGC symbol 512 may be placed immediately ahead of the first one of the 12 SL-RS symbols 516. The gap symbol 518 may be placed at the end of the dedicated slot 504.

In some embodiments, a shorter length of SL-RS (e.g., shorter than the 12-symbol length) may be configured in a slot. The number of symbols for a SL-RS may be configured as a smaller one and there may be more than one chances for SL-RS transmission within a slot. In some embodiments, an AGC symbol may be configured as being ahead of a starting symbol of the symbols for each SL-RS.

For example, as illustrated in FIG. 5B, two symbols 516 may be configured for a SL-RS and there may be a total of four 2-symbol SL-RSs within the dedicated slot 504. In this example, an AGC symbol 512 may be placed immediately ahead of the first SL-RS symbol 516 of each 2-symbol SL-RS, and a gap symbol 518 is placed at the end of the dedicated slot 504. A remaining symbol may be defined as a PSCCH symbol 514.

In another example, as illustrated in FIG. 5C, four symbols 516 may be configured for a SL-RS and there may be a total of two 4-symbol SL-RSs within the dedicated slot 504. In this example, an AGC symbol 512 may be placed immediately ahead of the first SL-RS symbol 516 of each 4-symbol SL-RS, gap symbols 518 may be placed at the end of the dedicated slot 504 and between the two 4-symbol SL-RSs. A PSCCH symbol 514 may be defined in the slot.

In another example, as illustrated in FIG. 5D, six symbols 516 may be configured for a SL-RS and there may be a total of two 6-symbol SL-RS within the dedicated slot 504. In this example, an AGC symbol 512 may be placed immediately ahead of the first SL-RS symbol 516 of each 6-symbol SL-RS.

In some embodiments, the structure of the dedicated slot for a SL resource pool used in a resource pool set may depend on whether SCI (e.g., PSCCH) is to be contained in the dedicated slot. As such, a dedicated slot may include an AGC symbol(s) and SL-RS symbols with SCI (e.g., PSCCH symbols in FIG. 5B and FIG. 5C) or without SCI (e.g., in FIG. 5A and FIG. 5D).

It would be appreciated that the number of symbols and the symbol types provided in FIG. 5A to 5D are for the purpose of illustration. Depending on the total number of symbols in a slot and other required information carried in a slot, the symbols for SL-RS may be defined in other way.

In some embodiments, depending on the predefined structure(s) of the dedicated slot for a SL resource pool, when considering specific resources for transmitting a SL-RS, the first resource allocation configuration may indicate the number of symbols and respective locations of the symbols for communication of the SL-RS within the dedicated slot. The locations of the symbols may be indicated by corresponding symbol indexes. For example, if the structure in FIG. 5B is applied and the first one of the four 2-symbol SL-RS is allocated, the number of symbols may be 2, and the locations of the symbols may indicate the third and fourth symbols in the dedicated slot 504.

It has been discussed above some example embodiments related to the first resource allocation configuration based on a resource pool set. In some embodiments, information indicating the first resource allocation configuration may be transmitted in SCI and/or a MAC CE, so as to indicate the resource pool set and specific resource allocated or reserved from the resource pool set for SL-RS transmission. In some embodiments of SL positioning where a SL-PRS is transmitted, information related to the positioning signal/channel (such as the SL-PRS, and measurement report) and the positioning procedure may be transmitted in SCI and/or a MAC CE.

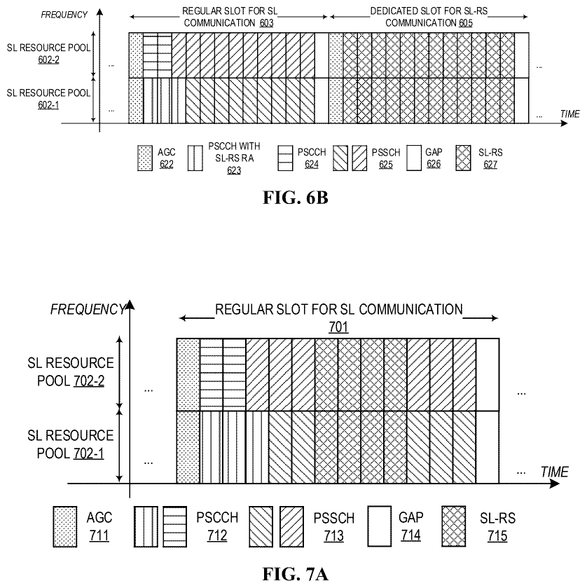

In some embodiments, the information indicating the first resource allocation configuration may be carried in at least one first resource for control information within at least one SL resource pool in the resource pool set. In some embodiments, the SL resource pool for carrying the information indicating the first resource allocation may be selected as a SL resource pool with a relatively low sub-channel, such as with the lowest sub-channel in the frequency domain. FIG. 6A illustrates such an example, where SL resource pools 602-1 and 602-2 within a dedicated slot 601 are allocated for SL-RS communication. The SL resource pool 602-1 has lower sub-channels as compared with the SL resource pool 602-2. Thus, the information indicating the first resource allocation configuration may be carried in a resource for control information within the SL resource pool 602-1. The resource for control information may include a PSCCH symbol in the dedicated slot. In some examples, for a symbol in the dedicated slot 601 for control information, the lowest sub-channel of the symbol may be configured to carry the information related to the first resource allocation configuration for a SL-RS, for example, the lower bottom of a PSCCH symbol 614. The remaining symbols in the SL resource pools 602-1 and 602-2 may be configured as an AGC symbol 612, SL-RS symbols 616, and a gap symbol 618.

In some embodiments, a SL resource pool may be randomly selected from the resource pool set for conveying the information related to the first resource allocation configuration for a SL-RS.

In some embodiments, the information indicating the first resource allocation configuration may be carried in at least one second resource for control information within at least one further resource pool for SL communication. The further SL resource pool may not be configured into the resource pool set, for example, when a dedicated slot is configured for SL-RS transmission. A time location of the at least one second resource may be ahead of time locations of resources within a dedicated time slot for SL-RS.

For example, in FIG. 6B, SL resource pools 602-1 and 602-3 in a regular slot 603 are used for SL communication, and SL resource pools 602-1 and 602-3 in a following dedicated slot 605 are used for only SL-RS communication. In addition to AGC symbols 622 and gap symbols 625, SL resource pools 602-1 and 602-3 in the regular slot 603 may be mainly configured for SL data transmission, such as via physical sidelink shared channel (PSCCH) symbols 625.

The information indicating the first resource allocation configuration in the dedicated slot 605 for SL-RS communication may be carried in a resource from the regular slot 603. For example, PSCCH symbols 623 in the SL resource pool 602-1 with the lowest sub-channel may be configured for carrying the information. PSCCH symbols 624 in the SL resource pool 602-2 may be used for carrying other control information. In such as case, symbols in the dedicates slot 605 may be mainly used for SL-RS transmissions, for example, configured as SL-RS symbols 627 in addition to the AGC symbols 622 and gap symbols 626.

In some embodiments, based on the (pre)configuration of the positioning of the dedicated slot for SL-RS across the plurality of SL resource pools and corresponding SL-RS resource (pre)configuration, a brief trigger may be carried as control information (e.g., in SCI) to activate the first resource allocation configuration. Based on the trigger, a communication device(s) 110 acting as the RX device(s) may be notified for the intended SL-RS transmission. In some embodiments, at the same time, a limited amount of additional information, such as an identity of the allocated SL-RS resource and a time offset, also may be included as the trigger to allow the RX device to determine the specific resource used at this time. In some embodiments, the SL-RS resource indication may be conveyed within the dedicated slot, for example in a form of trigger. For example, in FIG. 6A, a SL-RS trigger is carried in the PSCCH symbol 614, to activate the first resource allocation configuration which indicates the resource pool set.

In some embodiments, the information indicating the first resource allocation configuration may comprise one or more specific SL-RS resource related parameters (e.g., FRIV or TRIV) to configure SL-RS resource allocation (RA) and a certain amount of information may need to be conveyed to the RX device(s). In such a case, more symbols in a slot may be configured to carry the information indicating the first resource allocation configuration. In some embodiments, a resource of a SL resource pool in a regular slot (for example, not for SL-RS communication) may be configured to carry the information indicating the first resource allocation configuration. For example, in FIG. 6B, more PSCCH symbols 623 in the regular slot 603 may be used to carry the information indicating the first resource allocation configuration. In this way, more resources in the dedicated slot 605 can be configured for SL-RS communication.

In some embodiments, a communication device 110 acting as a TX device (which may be a target device or an anchor device in the example of sidelink positioning) may transmit the information indicating the first resource allocation. A communication device(s) 110 acting as a RX device(s) may monitor the corresponding resource pool to receive the information indicating the first resource allocation.

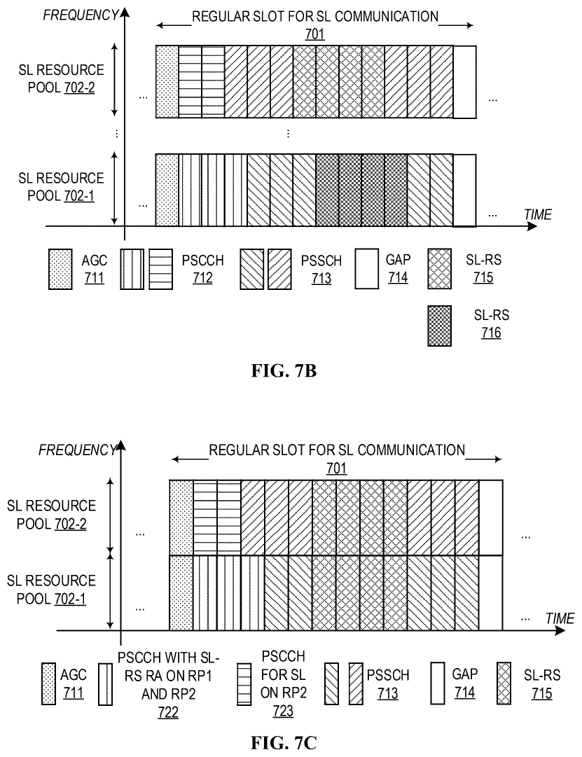

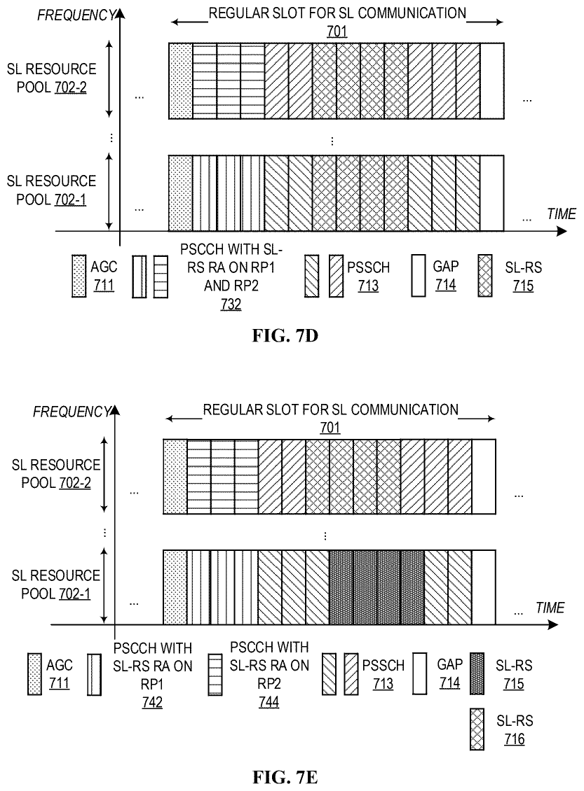

In some cases, when a SL-RS is conveyed across a plurality of SL resource pools in a resource pool set, SL communication and SL-RS communication may share the same resource pools in both the time domain and frequency domain, namely, no dedicated slot is configured for SL-RS transmission. A SL-RS may multiplex with other SL traffic data/information (such as PSSCH, PSCCH as well as the measurement report) with a slot In the case of the regular slot, in some embodiments, a same resource pattern in different SL resource pools in the resource pool set may be configured for a SL-RS within the regular slot, in order to simplify the SL-RS detection. In some examples, a resource pattern may be defined by symbols in the time domain. In some embodiments, within the regular slot, symbols in same time locations are configured in the plurality of SL resource pools. As illustrated in FIG. 7A, within SL resource pools 702-1 and 702-2 in a regular slot 701, symbols 715 with the same resource pattern in the two SL resource pools are allocated for SL-RS communication. The regular slot 701 may include other symbols in the two SL resource pools 702-1 and 702-2, including AGC symbols 711, PSCCH symbols 712 for control information, PSSCH symbols 713 for SL data transmission, and gap symbols 714.

In the case of the regular slot, in some embodiments, respective different resource patterns for communication of the sidelink reference signal in the plurality of resource pools. Those resource patterns may be staggered in the time domain. The different resource patterns may correspond to resources (e.g., symbols) at the plurality of resource pools that are partially overlapped in a time domain. As shown in FIG. 7B, different from the example of FIG. 7A, a resource pattern for a SL-RS in the SL resource pool 702-1 includes symbols 715 while a resource pattern for a SL-RS in the SL resource pool 702-2 includes SL-RS symbols 716 that are partially overlapped with the SL-RS symbols 715.

The staggered resource patterns for the SL-RS may be adapt to the regular SL traffic data in the SL resource pools in the case that SL traffic and the SL-RS are multiplexed in the same slot. For example, as compared with the SL resource pol 702-2, the SL resource pool 702-1 has more control information to be conveyed in PSCCH symbols 712 and thus the SL-RS may be placed in later symbols.

In some embodiments, the first resource allocation configuration may indicate the same or different resource patterns for SL-RS communication in the resource pool set, to allow the RX device to determine the symbols for the SL-RS.

In the case that the SL resource pools in the resource pool set are configured in regular slots, similarly as in the case of dedicated slot discussed above, the information indicating the first resource allocation configuration may be carried in a resource(s) for control information within any of the SL resource pools, a SL resource pool with a lower or lowest sub-channel in the frequency domain, or may be within a SL resource pool within which a SL-RS is transmitted.

For example, as illustrated in FIG. 7C, the information indicating the first resource allocation configuration for a SL-RS may be carried in PSCCH symbols 722 in the SL resource pool 702-1, to indicate SL-RS symbols 715 allocated for a SL-RS in both the SL resource pool 702-1 (“RP1”) and the SL resource pool 702-2 (“RP2”). In some examples, PSCCH symbols 723 in the SL resource pool 702-2 may be configured to indicate SL-RS symbols 715 allocated for a SL-RS in the SL resource pool 702-2 only.

In some embodiments, the information indicating the first resource allocation configuration may be equally contained in a resource for control information (e.g., the SCI) on each SL resource pool in the resource pool set to achieve diversity transmission. That is, the information indicating the first resource allocation configuration may be carried in respective resources for control information within the plurality of SL resource pools in the resource pool set, so as to allow for transmission diversity for the information and improve the detection accuracy of the information. In the sample of FIG. 7C, the same resource pattern is allocated in the two contiguous SL resource pools for the SL-RS. However, it would be appreciated that this may also be applied in the case of configuring different staggered resource patterns and non-contiguous SL resource pools.

For example, in FIG. 7D, the information indicating the first resource allocation configuration for a SL-RS may be carried in PSCCH symbols 732 in both of the SL resource pools 702-1 and 702-2. The PSCCH symbols 732 in each of the resource pools may indicate the same information for RA of SL-RS symbols 715 in both the resource pools. In the sample of FIG. 7D, the same resource pattern is allocated in the two non-contiguous SL resource pools for the SL-RS. However, it would be appreciated that this may also be applied in the case of configuring different staggered resource patterns and contiguous SL resource pools.

In some embodiments, the control information on each SL resource pool may contain the partial resource configuration related to this resource pool. Specifically, the information indicating the first resource allocation configuration may comprise a first information section related to a partial resource allocation configuration on a first SL resource pool in the resource pool set, a second information section related to a partial resource allocation configuration on a second SL resource pool in the resource pool set, and so on. The first information section may be carried in a resource for control information within the first resource pool, the second information section may be carried in a resource for control information within the second resource pool, and so on.

For example, as illustrated in FIG. 7E, PSCCH symbols 742 in the SL resource pool 702-1 are configured for carrying an information section related to SL-RS RA on the SL resource pool 702-1, while PSCCH symbols 744 in the SL resource pool 702-2 are configured for carrying an information section related to SL-RS RA on the SL resource pool 702-2. In the sample of FIG. 7E, different staggered resource patterns are allocated in the two non-contiguous SL resource pools for the SL-RS. However, it would be appreciated that this may also be applied in the case of configuring the same resource pattern and contiguous SL resource pools.

### Dedicated Resource Pool Based Configuration

In some embodiments, as mentioned above, in the second resource allocation configuration for a SL-RS, a dedicated resource pool may be configured for SL-RS communication. The configuration of dedicated resource pool for the SL-RS may help efficient resource usage in the dedicated resource pool for SL-RS transmission from devices on the same or different regular SL resource pools, and facilitate efficient resource allocation for SL-RS.

The frequency domain structure of the dedicated resource pool may be defined to enable flexible transmission of SL-RS. Specifically, the dedicated resource pool is divided in a frequency domain into a plurality of resource units, and a resource unit is of a predetermined bandwidth. The bandwidth of the dedicated resource pool may be configured or preconfigured to include an integer number of such resource units. The resource unit may be the minimum bandwidth for a SL-RS in the dedicated resource pool.

In some embodiments, the bandwidth of the resource unit (or frequency domain unit) may be determined based on the potential bandwidth granularity of physical resource blocks (PRBs) for a SL-RS and potential sub-channel bandwidth. In some embodiments, the potential granularity of PRB may include, for example, 4, 8, and/or 16 PRBs for a SL-RS. In some embodiments, the potential sub-channel bandwidth may include, for example, 10, 12, 15, 20, 25, 50, 75, or 100 PRBs for each sub-channel. In some embodiments, the predetermined bandwidth for a resource unit in the second resource allocation configuration is equal to an integer multiple of a least common multiple of a bandwidth granularity for the SL-RS and a sub-channel bandwidth, such as 12 PRBs, 20 PRBs, or 24 PRBs.

The resource units may be used as intervals in the dedicated resource pool. The dedicated resource pool may contain a set of evenly spaced resource unit for SL-RS resource. When allocating a specific resource(s) for a SL-RS, a number of (one or more) resource units may be allocated. That is, each SL-RS may be located on the grid of the resource unit in the frequency domain in the dedicated resource pool.

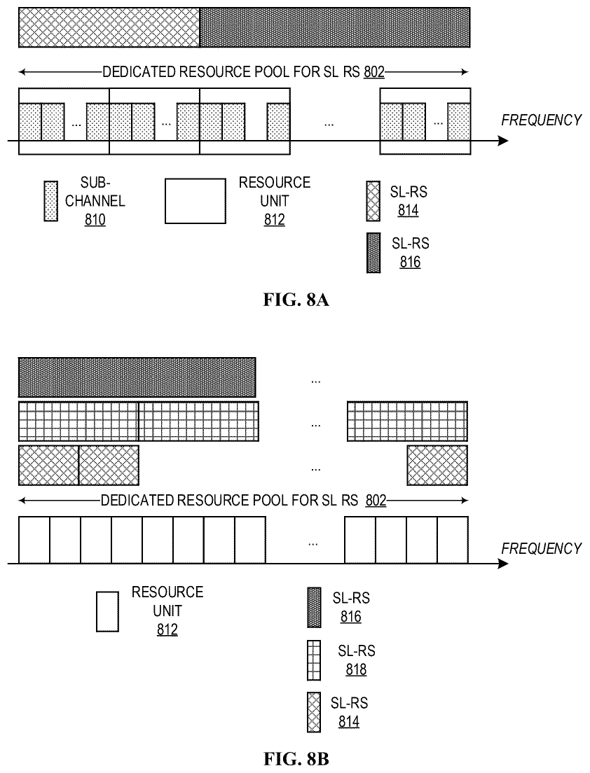

In some embodiments, a bandwidth of a SL-RS in the dedicated resource pool may be configured or preconfigured to include an integer number of resource units. For example, as illustrated in FIG. 8A, within a dedicated resource pool 802 for SL-RS, a resource unit 812 includes a plurality of sub-channels 810 in the frequency domain. Two resource units 812 are allocated for a SL-RS 814, and more than two resource units 816 are allocated for a SL-RS 816.

In some embodiments, the bandwidth configuration of a SL-RS in the dedicated resource pool may be classified in a way of integral multiple relationship, i.e., the bandwidth of a SL-RS may be equal to an integer multiple of that of other SL-RS. As a result, when allocating resource for two SL-RSs, a total bandwidth of the number of resource units allocated for a SL-RS may be equal to an integer multiple of a total bandwidth of a number of resource units for another SL-RS. For example, as illustrated in FIG. 8B, a total bandwidth of a SL-RS 816 is twice of that of the SL-RS 818, and a total bandwidth of a SL-RS 818 is twice of that of the SL-RS 814. Such classification in the frequency domain may allow best utilization of the bandwidth of the dedicated resource pool for SL-RS transmission. Different sizes of resource units may be allocated for transmitting different SL-RSs as needed.

Regarding the resource allocation of SL-RS on the dedicated resource pool, especially the resource allocation scheme by the communication device 110 without involvement of the network device, the resource allocation may follow a predetermined order in a frequency domain. Specifically, among the available resource block (RB), such as PRBs in the dedicated resource pool, the number of resource units indicated by the second resource allocation configuration may selected from the available RBs by following a predetermined order in a frequency domain. In this way, the resource utilization can be improved and fewer resource units may be left without being allocated.

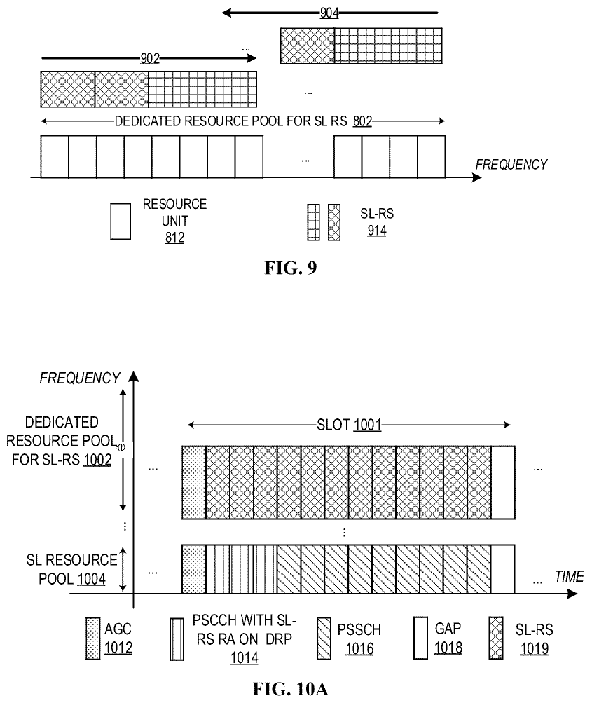

For example, as illustrated in FIG. 9, the order may be in a direction 902 from the bottom side to the top side in the frequency domain, i.e., from the lowest available PRB to the highest available PRB in the dedicated resource pool 802. Specifically, two resource units are selected from the first lowest PRB for a first SL-RS 914, two other resource units are further selected from new lowest available PRB for a second SL-RS 914, and so on. Alternatively, as illustrated in FIG. 9, the order may be in a direction 904 from the highest available PRB to the lowest available PRB. In this direction, a first SL-RS 914 may be allocated with four resource units from the highest PRB or highest resource unit.

In some embodiments, the order from the top side to the bottom side and the order from the bottom side to the top side may be randomly applied for the resource allocation. In some embodiments, the resource units for a SL-RS may be randomly selected from the dedicated resource pool.

In some embodiments, if a dedicated resource pool is configured for SL-RS communication, a slot for the dedicated resource pool may be considered as a dedicated slot for SL-RS communication. In some embodiments, the structure of the dedicated slot may be similar as the one discussed in the case of resource pool set based configuration, for example, similar as those illustrated in FIG. 5A to FIG. 5D. Thus, a single 12-symbol SL-RS with a single AGC, or multiple 2-symbol, 4-symbol, or 6-symbol SL-RS with multiple AGCs may be contained in the dedicated slot, without or without SCI. The structure of the dedicated slot may be designed considering various factors. In some embodiments, the second resource allocation configuration may further indicate the number of symbols and respective locations of the symbols for communication of the sidelink reference signal within a time slot.

It has been discussed above some example embodiments related to the second resource allocation configuration based on a dedicated resource pool set. In some embodiments, information indicating the second resource allocation configuration may be transmitted in SCI and/or a MAC CE, to indicate the dedicated resource pool set and the resource units in the dedicated resource pool allocated for SL-RS transmission.

In some embodiments, the information indicating the second resource allocation configuration may be carried in a resource for control information within the dedicated resource pool. In some embodiments, the information indicating the second resource allocation configuration may be carried in a resource for control information within a further resource pool for SL communication other than the dedicated resource pool, such as within a regular SL resource pool.

In some embodiments, if the dedicated resource pool is associated with one regular SL resource pool, that is, all SL-RS transmissions on the dedicated resource pool are transmitted by the communication devices 110 sharing the same SL resource pool, the information indicating the second resource allocation configuration may be conveyed only in the SCI on the regular SL resource pool, for example, as a new field of legacy SCI format, or a field of new format SCI.

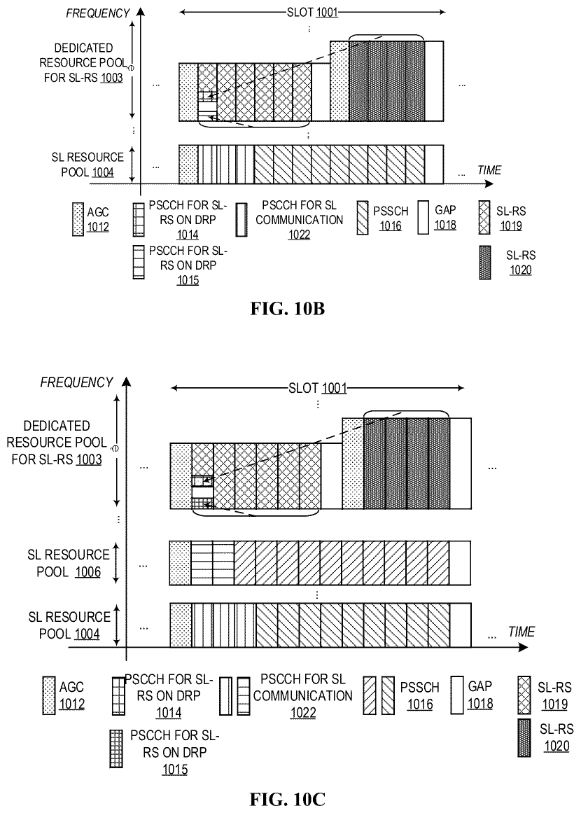

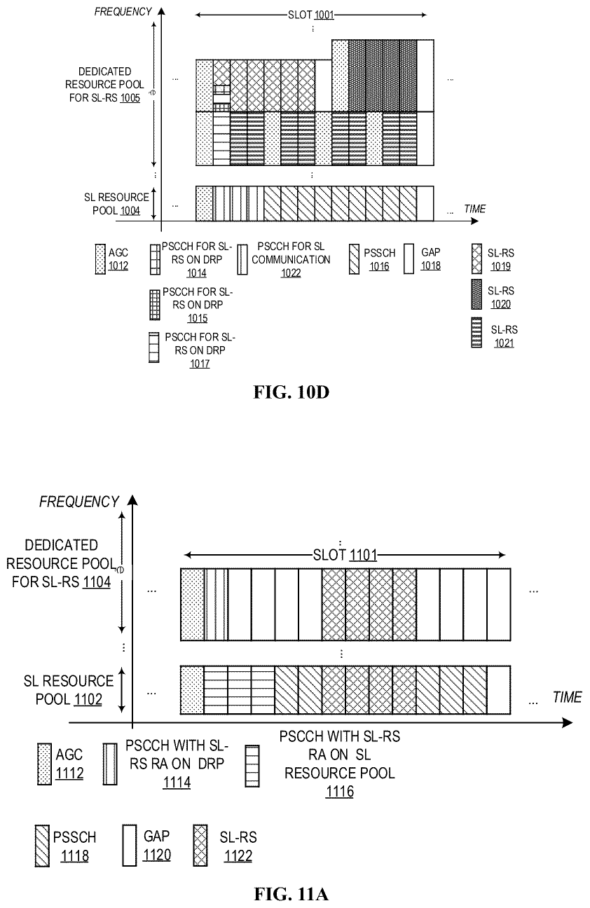

As illustrated in FIG. 10A, a dedicated resource pool 1002 for SL-RS is associated with a regular SL resource pool 1004 in a slot 1001. The information indicating the second resource allocation configuration may be carried in a resource for control information within the SL resource pool 1004, for example, in PSCCH symbols 1014. The PSCCH symbols 1104 indicates SL resource allocation on the dedicated resource pool 1002. The remaining symbols in the SL resource pool 1004 may be configured as an AGC symbol 1012, PSSCH symbols 1016 for SL data, and gap symbols 1018. The symbols in the dedicated resource pool 1002 may be configured as SL-RS symbols 1019 in addition to an AGC symbol 1012 and a gap symbol 1018.

In some embodiments, similar to in the case of resource pool set based configuration, based on certain requirement such as different resource allocation schemes, the information indicating the second resource allocation configuration may take the form of a comprehensive information including FRIV, TRIV and etc., or a simple indication as a trigger. Such information may also be carried in the regular SL resource pool.

In some embodiments, the information indicating the second resource allocation configuration may be conveyed in a new format SCI (such as format 1-X) in the dedicated resource pool, such as on the lowest sub-channel corresponding to the intending SL-RS transmission on the dedicated resource pool. The SCI format 1-X may include the SL-RS resource indication/reservation and occupy one or two symbols in a slot. For time-division multiplexing (TDM) of the overlapped or partially overlapped SL-RS resources on frequency domain within a slot, if the lowest sub-channel is (partly) occupied for the SCI transmission related to one SL-RS, then the sub-channel adjacent to the lowest one may be used for SCI transmission related to another SL-RS, and so forth according to the time order of different SL-RSs within the slot, accordingly a predetermined number of (e.g., M) lowest sub-channels may be reserved only for conveying SCI.

As illustrated in FIG. 10B, for a resource pool 1003 dedicated for SL-RS and associated with the SL resource pool 1004, a sub-channel 1014 in a PSCCH symbol of the dedicated resource pool 1003 is used to carry information related to resource allocation configuration for SL-RS symbols 1020 allocated for a first SL-RS, and a sub-channel 1015 in the PSCCH symbol of the dedicated resource pool 1003 is used to carry information related to resource allocation configuration for SL-RS symbols 1019 allocated for a second SL-RS. According to this configuration, a SL-RS in the SL-RS symbols 1019 and a SL-RS in the SL-RS symbols 1020 may be communicated in a TDM manner. PSCCH symbols 1022 in the SL resource pool 1004 can be configured for carrying SCI for regular SL communication.

In some embodiments, if the dedicated resource pool is associated with a plurality of regular SL resource pools, namely the communication devices 110 on the different regular SL resource pools may share the dedicated resource pool to transmit SL-RS. In this case, for at least the associated SL resource pools with the resource allocation scheme by the communication devices 110 without involvement of the network device, the information related to the second resource allocation configuration may be conveyed in a new format SCI (such as format 1-X) on the dedicated resource pool, such as on the lowest sub-channel corresponding to intending SL-PRS transmission on the dedicated resource pool. For example, as illustrated in FIG. 10C, the dedicated resource pool 1003 for SL-RS is associated with the SL resource pool 1004 and a SL resource pool 1006. The sub-channel 1014 in the PSCCH of the dedicated resource pool 1003 is used to carry information related to resource allocation configuration for SL-RS symbols 1020 allocated for a first SL-RS, and a sub-channel 1015 in the PSCCH symbol of the dedicated resource pool 1003 is used to carry information related to resource allocation configuration for SL-RS symbols 1019 allocated for a second SL-RS. PSCCH symbols 1022 in the SL resource pools 1004 and 1006 can be configured for carrying SCI for regular SL communication.

Alternatively, similar to the above case where the dedicated resource pool is associated with one regular SL resource pool, the adjacent sub-channels may be used for the TDM SL-PRSs with a slot.

As illustrated in FIG. 10D, a dedicated resource pool 1005 may be configured for communication of TDM SL-RSs in a slot 1001. In addition to the sub-channels 1014 and 1015, a PSCCH symbol 1017 in the lowest subchannels may also be configured for carrying information related to resource allocation configuration for SL-RS symbols 1021. A SL-RS in the SL-RS symbols 1021 may be communicated in a frequency-division multiplexing (FDM) manner with the SL-RSs in the SL-RS symbols 1019 and 1020.

In some embodiments, a SL-RS(s) may be transmitted on both the dedicated resource pool and an associated SL resource pool contiguous or non-contiguous with the dedicated resource pool. For example, in the resource pool set based configuration, a resource pool set may be configured to comprise one or more dedicated resource pools for SL-RS and one or more regular SL resource pools. In some embodiments, the resources allocated from such a resource pool set may be based on the resource allocation scheme with or without the network device involvement (Model or Mode2) applied for the SL-RS communication.

In some embodiments, the information indicating the resource allocation configuration related to the resource pool set may be similar as discussed above. In some embodiments, the information indicating the resource allocation configuration may be partly conveyed in the new format SCI (such as format 1-X) on the lowest sub-channel corresponding to intending SL-RS transmission on the dedicated resource pool. At the same time, the remaining information corresponding to the intending SL-RS transmission on the regular SL resource pool may be conveyed in the SCI transmitted on the regular SL resource pool. That is, the SL-RS resources on the regular SL resource pool and the dedicated resource pool are separately indicated in the SCI on corresponding resource pools.

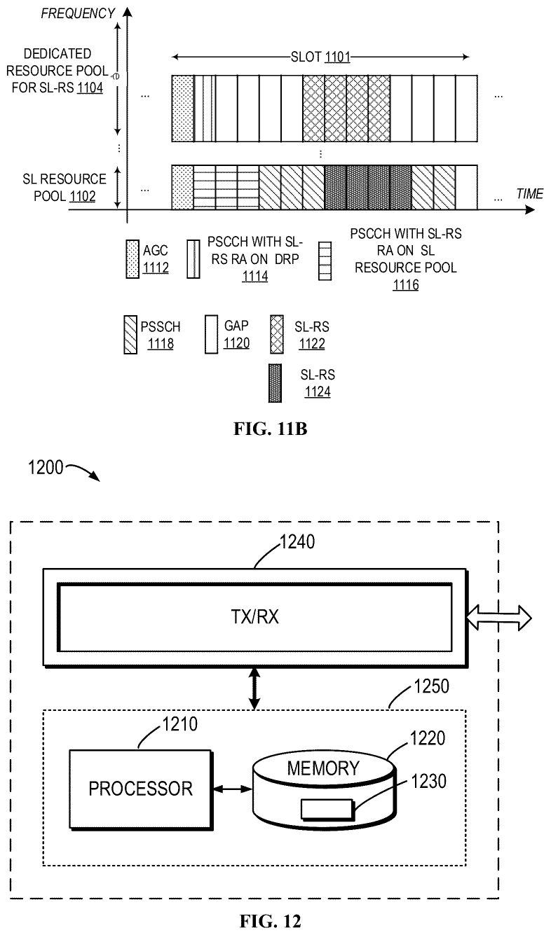

As illustrated in FIG. 11A, a regular SL resource pool 1102 and a dedicated resource pool for SL-RS are comprised in a resource pool set. In a slot 1101, a PSCCH symbol 1114 in the dedicated resource pool 1104 may be configured to convey an information section indicating SL-RS symbols 1122 in the dedicated resource pool 1104, and PSCCH symbols 1116 in the SL resource pool 1102 may be configured to convey an information section indicating SL-RS symbols 1122 in the SL resource pool 1102. The remaining symbols in the resource pool set may include AGC symbols 1112, PSCCH symbols 1118 in the SL resource pool 1102, and gap symbols 1120.

In some embodiments, similar to the resource pool set with all SL resource pools, the identical or staggered resource patterns may be configured for the dedicated resource pool(s) and the SL resource pool(s). For example, in FIG. 11A, the SL-RS symbols 1122 in the SL resource pool 1102 and the dedicated resource pool 1104 have the same resource pattern. In another example shown in FIG. 11B, SL-RS symbols 1122 in the dedicated resource pool 1104 has a different resource pattern from SL-RS symbols 1124 in the SL resource pool 1102. The two resource patterns are staggered in the time domain.

It would be appreciated that the examples and structures in FIG. 10A to FIG. 11B are provided for the purpose of illustration. There will be many variants to the slot structure, and the scope of the present disclosure is not limited in this regard.

### EXAMPLE DEVICE

FIG. 12 is a simplified block diagram of a device 1200 that is suitable for implementing embodiments of the present disclosure. The device 1200 can be considered as a further example implementation of the communication device 110 or the communication device 120 as shown in FIG. 1. Accordingly, the device 1200 can be implemented at or as at least a part of the communication device 110 or the communication device 120.

As shown, the device 1200 includes a processor 1210, a memory 1220 coupled to the processor 1210, a suitable transmitter (TX)/receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 1 to 11B. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a communication device (for example, a terminal device) comprises a circuitry configured to: obtains a resource allocation configuration for a sidelink reference signal, the resource allocation configuration comprising: a first resource allocation configuration indicating a resource pool set and a time-frequency location in the resource pool set, the resource pool set comprising a plurality of resource pools for sidelink communication, or a second resource allocation configuration indicating a number of resource units selected from a dedicated resource pool for communication of the sidelink reference signal, a resource unit being of a predetermined bandwidth; determines a resource allocated for the sidelink reference signal based on the resource allocation configuration; and performs communication of the sidelink reference signal with at least one second communication device using the determined resource.

In some embodiments, the plurality of resource pools are partially overlapped in a time domain and comprise at least one of the following: at least two resource pools that are contiguous in a frequency domain, or at least two resource pools that are non-contiguous in the frequency domain.

In some embodiments, the resource allocation configuration comprises the first resource allocation configuration. In some embodiments, the circuitry is configured to perform the communication of the sidelink reference signal by: in accordance with a determination that a frequency gap between the plurality of resource pools exceeds a frequency threshold, applying an independent detection of the sidelink reference signal on each of the plurality of resource pools; and in accordance with a determination that the frequency gap is within the frequency threshold, applying a joint detection of the sidelink reference signal on the plurality of resource pools.

In some embodiments, the first resource allocation configuration further indicates a dedicated time slot for the sidelink reference signal.

In some embodiments, the first resource allocation configuration further indicates a periodicity of the dedicated time slot.

In some embodiments, the first resource allocation configuration or the second resource allocation configuration further indicates the number of symbols and respective locations of the symbols for communication of the sidelink reference signal within a time slot.

In some embodiments, a symbol for automatic gain control (AGC) is comprised ahead of a starting symbol of the symbols for communication of the sidelink reference signal.

In some embodiments, information indicating the first resource allocation configuration is carried in: at least one first resource for control information within at least one resource pool in the resource pool set, or at least one second resource for control information within at least one further resource pool for sidelink communication, a time location of the at least one second resource being ahead of time locations of resources within a dedicated time slot for the sidelink reference signal.

In some embodiments, the information indicating the first resource allocation configuration is carried in respective resources for control information within the plurality of resource pools in the resource pool set.

In some embodiments, the information indicating the first resource allocation configuration comprises a first information section related to a partial resource allocation configuration on a first resource pool in the resource pool set and a second information section related to a partial resource allocation configuration on a second resource pool in the resource pool set. In some embodiments, the first information section is carried in a resource for control information within the first resource pool, and the second information section is carried in a resource for control information within the second resource pool.

In some embodiments, information indicating the second resource allocation configuration is carried in: a third resource for control information within the dedicated resource pool, or a fourth resource for control information within a further resource pool for sidelink communication other than the dedicated resource pool.

In some embodiments, information indicating the first resource allocation configuration or the second resource allocation configuration comprises at least one parameter for the first resource allocation configuration or a trigger to activate the first resource allocation configuration.

In some embodiments, the first resource allocation configuration further indicates: a resource pattern for communication of the sidelink reference signal in the plurality of resource pools, or respective different resource patterns for communication of the sidelink reference signal in the plurality of resource pools, the respective different resource patterns corresponding to resources at the plurality of resource pools that are partially overlapped in a time domain.

In some embodiments, the predetermined bandwidth for a resource unit in the second resource allocation configuration is equal to an integer multiple of a least common multiple of a bandwidth granularity for the sidelink reference signal and a sub-channel bandwidth.

In some embodiments, a total bandwidth of the number of resource units for the sidelink reference signal is equal to an integer multiple of a total bandwidth of a further number of resource units for a further sidelink reference signal.

In some embodiments, the dedicated resource pool comprises a plurality of physical blocks (RBs), and the number of resource units indicated by the second resource allocation configuration are selected from available RBs within the dedicated resource pool by following a predetermined order in a frequency domain.

In some embodiments, the plurality of resource pools in the resource pool set comprises the dedicated resource pool.

In some embodiments, the circuitry is configured to obtain the resource allocation configuration by: receiving information indicating the resource allocation configuration from a third communication device.

In some embodiments, the circuitry is further configured to transmit, to the at least one second communication device, information indicating the resource allocation configuration.

In some embodiments, the circuitry is configured to the sidelink reference signal comprises a sidelink positioning reference signal (SL-PRS).

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a communication method: obtaining, at a first communication device, a resource allocation configuration for a sidelink reference signal, the resource allocation configuration comprising: a first resource allocation configuration indicating a resource pool set and a time-frequency location in the resource pool set, the resource pool set comprising a plurality of resource pools for sidelink communication, or a second resource allocation configuration indicating a number of resource units selected from a dedicated resource pool for communication of the sidelink reference signal, a resource unit being of a predetermined bandwidth; determining a resource allocated for the sidelink reference signal based on the resource allocation configuration; and performing communication of the sidelink reference signal with at least one second communication device using the determined resource.

In some embodiments, the plurality of resource pools are partially overlapped in a time domain and comprise at least one of the following: at least two resource pools that are contiguous in a frequency domain, or at least two resource pools that are non-contiguous in the frequency domain.

In some embodiments, the resource allocation configuration comprises the first resource allocation configuration, and wherein performing the communication of the sidelink reference signal comprises: in accordance with a determination that a frequency gap between the plurality of resource pools exceeds a frequency threshold, applying an independent detection of the sidelink reference signal on each of the plurality of resource pools; and in accordance with a determination that the frequency gap is within the frequency threshold, applying a joint detection of the sidelink reference signal on the plurality of resource pools.

In some embodiments, the first resource allocation configuration further indicates a dedicated time slot for the sidelink reference signal.

In some embodiments, the first resource allocation configuration further indicates a periodicity of the dedicated time slot.

In some embodiments, the first resource allocation configuration or the second resource allocation configuration further indicates the number of symbols and respective locations of the symbols for communication of the sidelink reference signal within a time slot In some embodiments, a symbol for automatic gain control (AGC) is comprised ahead of a starting symbol of the symbols for communication of the sidelink reference signal.

In some embodiments, information indicating the first resource allocation configuration is carried in: at least one first resource for control information within at least one resource pool in the resource pool set, or at least one second resource for control information within at least one further resource pool for sidelink communication, a time location of the at least one second resource being ahead of time locations of resources within a dedicated time slot for the sidelink reference signal.

In some embodiments, the information indicating the first resource allocation configuration is carried in respective resources for control information within the plurality of resource pools in the resource pool set.

In some embodiments, the information indicating the first resource allocation configuration comprises a first information section related to a partial resource configuration on a first resource pool in the resource pool set and a second information section related to a partial resource configuration on a second resource pool in the resource pool set, and the first information section is carried in a resource for control information within the first resource pool, and the second information section is carried in a resource for control information within the second resource pool.

In some embodiments, information indicating the second resource allocation configuration is carried in: a third resource for control information within the dedicated resource pool, or a fourth resource for control information within a further resource pool for sidelink communication other than the dedicated resource pool.

In some embodiments, information indicating the first resource allocation configuration or the second resource allocation configuration comprises at least one parameter for the first resource allocation configuration or a trigger to activate the first resource allocation configuration.

In some embodiments, the first resource allocation configuration further indicates: a resource pattern for communication of the sidelink reference signal in the plurality of resource pools, or respective different resource patterns for communication of the sidelink reference signal in the plurality of resource pools, the respective different resource patterns corresponding to resources at the plurality of resource pools that are partially overlapped in a time domain.

In some embodiments, the predetermined bandwidth for a resource unit in the second resource allocation configuration is equal to an integer multiple of a least common multiple of a bandwidth granularity for the sidelink reference signal and a sub-channel bandwidth.

In some embodiments, a total bandwidth of the number of resource units for the sidelink reference signal is equal to an integer multiple of a total bandwidth of a further number of resource units for a further sidelink reference signal.

In some embodiments, the dedicated resource pool comprises a plurality of physical blocks (RBs), and the number of resource units indicated by the second resource allocation configuration are selected from available RBs within the dedicated resource pool by following a predetermined order in a frequency domain.

In some embodiments, the plurality of resource pools in the resource pool set comprises the dedicated resource pool.

In some embodiments, obtaining the resource allocation configuration comprises: receiving information indicating the resource allocation configuration from a third communication device.

In some embodiments, the method further comprises: transmitting, to the at least one second communication device, information indicating the resource allocation configuration.

In some embodiments, the sidelink reference signal comprises a sidelink positioning reference signal (SL-PRS).

In another solution, a communication device comprises: at least one processor; and at least one memory storing instructions that, when executed by the at least one processor, cause the device to perform any of the methods above.

In a further solution, a computer readable medium having instructions stored thereon, the instructions, when executed on at least one processor, causing the at least one processor to perform any of the methods above.

In a yet further solution, a computer program comprising instructions, the instructions, when executed on at least one processor, causing the at least one processor to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a first terminal device, comprising:
transmitting physical sidelink control channel (PSCCH) transmission with sidelink control information (SCI) in a sub-channel in a dedicated sidelink (SL) positioning reference signal (PRS) resource pool,
wherein the sub-channel for the PSCCH transmission is determined based on a corresponding SL PRS resource scheduled by the SCI on the PSCCH transmission within a same slot; and
transmitting SL PRS on the corresponding SL PRS resource.

22. The method of claim 21, wherein the SCI comprises first information for requesting a further SL PRS transmission.

23. The method of claim 21, wherein the SL PRS resource occupies consecutive symbols within a slot, and a last symbol in the slot serves as a guard symbol.

24. The method of claim 21, further comprising: transmitting a further SCI for scheduling a further SL PRS,
wherein the further SCI comprises fields included in SCI format 2-A or SCI format 2-B.

25. A method performed by a second terminal device, comprising:
receiving physical sidelink control channel (PSCCH) transmission with sidelink control information (SCI) in a sub-channel in a dedicated sidelink (SL) positioning reference signal (PRS) resource pool,
wherein the sub-channel for the PSCCH transmission is determined based on a corresponding SL PRS resource scheduled by the SCI on the PSCCH transmission within a same slot; and
receiving SL PRS on the corresponding SL PRS resource.

26. The method of claim 25, wherein the SCI comprises first information for requesting a further SL PRS transmission.

27. The method of claim 25, wherein the SL PRS resource occupies consecutive symbols within a slot, and a last symbol in the slot serves as a guard symbol.

28. The method of claim 25, further comprising: receiving a further SCI for scheduling a further SL PRS,
wherein the further SCI comprises fields included in SCI format 2-A or SCI format 2-B.

29. A first terminal device, comprising a processor configured to:
transmit physical sidelink control channel (PSCCH) transmission with sidelink control information (SCI) in a sub-channel in a dedicated sidelink (SL) positioning reference signal (PRS) resource pool,
wherein the sub-channel for the PSCCH transmission is determined based on a corresponding SL PRS resource scheduled by the SCI on the PSCCH transmission within a same slot; and
transmit SL PRS on the corresponding SL PRS resource.

30. The first terminal device of claim 29, wherein the SCI comprises first information for requesting a further SL PRS transmission.

31. The first terminal device of claim 29, wherein the SL PRS resource occupies consecutive symbols within a slot, and a last symbol in the slot serves as a guard symbol.

32. The first terminal device of claim 29, wherein the processor is further configured to cause the first terminal device to: transmit a further SCI for scheduling a further SL PRS,
wherein the further SCI comprises fields included in SCI format 2-A or SCI format 2-B.
